(19) United States
(12) Patent Application Publication
(10) Pub. No.: US 2006/0255917 A1
(43) Pub. Date: Nov. 16, 2006

(54) System for protecting tag related information and method thereof

(75) Inventors: Kyung-ho Park, Suwon-si (KR); Woo-shik Kang, Suwon-si (KR); Hyung-min Yoon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/431,041

(22) Filed: May 10, 2006

(30) Foreign Application Priority Data
May 10, 2005 (KR) 10-2005-0039032
Apr. 12, 2006 (KR) 10-2006-0033233

(51) Int. Cl. H04Q 5/22

(52) U.S. Cl. 340/10.1; 340/572.1

(57) ABSTRACT

A system for protecting signal emitting tag related information and a method thereof are provided. The method of protecting the signal emitting tag related information includes operations of receiving a request for the signal emitting tag related information, which is information related to a the signal emitting tag, and providing the requested signal emitting tag related information after authenticating the request. Therefore, a non-permitted user can be prevented from reading the signal emitting tag related information so that the signal emitting tag related information can be protected.

### CROSS-REFERENCE TO RELATED APPLICATIONS

This application claims priority from Korean Patent Application No. 10-2005-0039032 filed on May 10, 2005, and Korean Patent Application No. 10-2006-0033233 filed on Apr. 12, 2006 in the Korean Intellectual Property Office, the entire disclosures of which are incorporated herein by reference.

### BACKGROUND OF THE INVENTION

1. Field of the Invention

Methods and apparatuses consistent with the present invention relate to protecting tag related information, and more particularly, to a method of protecting tag related information and a system therefor that provides tag related information, which is information related to a product to which a tag is attached, after an authentication process, or after an encoding process so as to restrict the tag related information to be read.

2. Description of the Related Art

As radio technology has been developed, various radio frequency identification (RFID) systems have been utilized such as prepaid bus cards, parking lot admission tickets, and identification (ID) cards to laboratory.

In an RFID system, a tag, a reader and a server are connected with one another. The reader may be employed to various terminal devices such as a mobile phone, a PDA and a laptop computer. The tag may be implemented as a card type, which can be held by a user, such as an ID card and a bus card or as a sticker type, which is stuck on a general product to transmit product information.

In an RFID system, a reader requests and receives tag related information, which is information regarding a tag to provide the information through a display to a user.

Conventionally, an RFID system has a fixed reader and a moving tag. However, the recent RFID system can have a fixed tag and a mobile reader. Accordingly, it is easier to read a tag attached to another person's product by a reader so as to be easier to read tag related information regarding the tag attached to the other person's product.

The tag related information probably needs be protected. However, it is impossible up to now to prevent an unspecified person from reading the tag related information using a reader.

### SUMMARY OF THE INVENTION

Accordingly, aspects of the present invention address the above problem. An aspect of the present invention provides a method of protecting signal emitting tag related information and a system thereof that provides the signal emitting tag related information, which is information related to a signal emitting tag, after an authentication process, or after an encoding process to protect the signal emitting tag related information such that a non-permitted user can be prevented from reading the signal emitting tag related information.

According to an aspect of the present invention, there is provided a method of protecting signal emitting tag related information including operations of receiving a request for the signal emitting tag related information, and providing the signal emitting tag related information after authenticating the request.

The method may further include operations of determining whether protection for the signal emitting tag related information is set. The signal emitting tag related information may be provided after the authenticating if it is determined that the protection is set.

The operation of providing the signal emitting tag related information may include operations of, if it is determined that the protection is set, requesting authentication information necessary for the authenticating, receiving authentication information from a user and determining whether the signal emitting tag related information is permitted to be read using the authentication information, and, if it is determined that the signal emitting tag related information is permitted to read in the operation, providing the signal emitting tag related information.

The authentication information may include at least one of information regarding a reader requesting the signal emitting tag related information, a terminal to which the reader is employed, and information regarding a user of the reader or the terminal.

The aforementioned operation may further include operations of, if it is determined that the signal emitting tag related information is not permitted to be read, requesting a registered password for the tag related information, determining whether the signal emitting tag related information is permitted to be read using a password received in response to the requesting of the registered password, and, if it is determined that the signal emitting tag related information is permitted to be read according to the received password, providing the signal emitting tag related information.

The aforementioned operation may further include operations of, if it is determined that the signal emitting tag related information is not permitted to be read according to the received password, transmitting a signal which represents not permitting reading of the signal emitting tag related information.

The aforementioned operation may receive authentication information, which is information necessary for the authenticating, together with the request for the signal emitting tag related information.

The aforementioned method may further include operations of requesting to set protection for the signal emitting tag related information, and setting the protection for the signal emitting tag related information.

According to an aspect of the present invention, there is provided a system for protecting signal emitting tag related information, the system including a reader sending a request for the signal emitting tag related information, and a server providing the signal emitting tag related information requested from the reader to the reader after authenticating the request.

If it is determined that protection for the signal emitting tag related information is set, the server may provide the signal emitting tag related information to the reader after the authenticating.

If it is determined that the protection for the signal emitting tag related information is set, the server may determine whether to provide the signal emitting tag related information, based on authentication information, which is information necessary for the authenticating.

According to an aspect of the present invention, there is provided a signal emitting tag related information providing apparatus including a communicator which receives a request for signal emitting tag related from a reader, and a processor which provides the signal emitting tag related information through the communicator to the reader after authenticating the request.

If it is determined that protection for the signal emitting tag related information is set, the processor may provide the signal emitting tag related information through the communicator to the reader after the authenticating.

If it is determined that the protection for the signal emitting tag related information is set, the processor may determine whether the signal emitting tag related information is provided, based on authentication information that is information necessary for the authenticating.

According to an aspect of the present invention, there is provided a method of protecting signal emitting tag related information including operations of receiving a request for signal emitting tag related information, encoding the signal emitting tag related information, and providing the encoded signal emitting tag related information.

The method may further include an operation of determining whether protection for the signal emitting tag related information is set. The encoding of the signal emitting tag related information may be performed if it is determined that the protection is set.

The method may further include operations of receiving a signal emitting tag ID and a request for setting protection for the signal emitting tag related information, and setting the protection using the signal emitting tag ID.

In the aforementioned method, the operation of receiving the signal emitting tag ID may further include receiving an owner ID which specifies the owner of the product to which the signal emitting tag is attached, and the operation of setting the protection may be performed if the received owner ID matches a pre-stored owner ID.

The aforementioned method may further include operations of transmitting an authentication key used for decoding the signal emitting tag related information, the protection of which is set, to a requester of the signal emitting tag related information.

The aforementioned method may further include operations of receiving a signal emitting tag ID, a new owner ID, and an owner change request, and changing an existing owner of the product to the owner specified by the received new owner ID.

According to an aspect of the present invention, there is provided a method of protecting signal emitting tag related information, including operations of sending a request for signal emitting tag related information, receiving encoded signal emitting tag related information in response to the request, and decoding the encoded signal emitting tag related information.

The aforementioned method may further include operations of transmitting an authentication key used for decoding the signal emitting tag related information to a terminal of a permitted user so that the permitted user can read the encoded signal emitting tag related information.

The authentication key may be provided from a server providing the encoded signal emitting tag related information.

The method may further include an operation of receiving an authentication key used for decoding the encoded signal emitting tag related information from another terminal which has received the authentication key.

### BRIEF DESCRIPTION OF THE DRAWINGS

The above aspects and features of the present invention will be more apparent by describing certain embodiments of the present invention with reference to the accompanying drawings, in which:

FIG. 1 is a block diagram of a system for protecting tag related information according to an exemplary embodiment of the present invention;

FIG. 2 is a flowchart for explaining a method of protecting tag related information according to an exemplary embodiment of the present invention;

FIG. 3 is a table comprising tag related information stored in a tag related information providing server according to an exemplary embodiment of the present invention;

FIG. 4 is a block diagram of a tag related information providing server illustrated in FIG. 1 according to an exemplary embodiment of the present invention;

FIG. 5 is a block diagram of a system for protecting tag related information according to another exemplary embodiment of the present invention;

FIG. 6 is a flowchart for explaining a method of protecting tag related information according to another exemplary embodiment of the present invention;

FIG. 7 is a table comprising tag related information pre-stored in a product information providing server according to an exemplary embodiment of the present invention; and

FIGS. 8 is a block diagram illustrating a product owner terminal 620 in FIG. 5 according to an exemplary embodiment of the present invention.

### DETAILED DESCRIPTION OF THE EXEMPLARY EMBODIMENTS

Exemplary embodiments of the present invention will be described in detail with reference to the annexed drawings. In the drawings, the same elements are denoted by the same reference numerals throughout the drawings. In the following description, detailed descriptions of known functions and configurations incorporated herein have been omitted for conciseness and clarity.

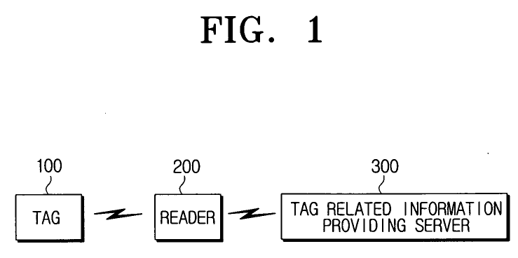

FIG. 1 is a block diagram illustrating a system for protecting tag related information according to an exemplary embodiment of the present invention. As shown in FIG. 1, the system for protecting the tag related information comprises an RFID tag (hereafter, referred to as “tag”) 100, an RFID-reader (hereafter, referred to “reader”) 200, and a tag related information providing server 300, which are connected with one another.

The reader 200 reads the tag 100 and requests the tag related information providing server 300 for tag related information, which is information regarding a product to which the tag 100 is attached. The reader 200 displays on a display the tag related information received from the tag related information providing server 300 so that a user can read the tag related information.

The tag related information providing server 300 may perform an authentication process to provide the tag related information to the reader 200. In other words, the tag related information providing server 300 can provide the tag related information after performing an authentication process so that a non-permitted user can be prevented from reading the tag related information.

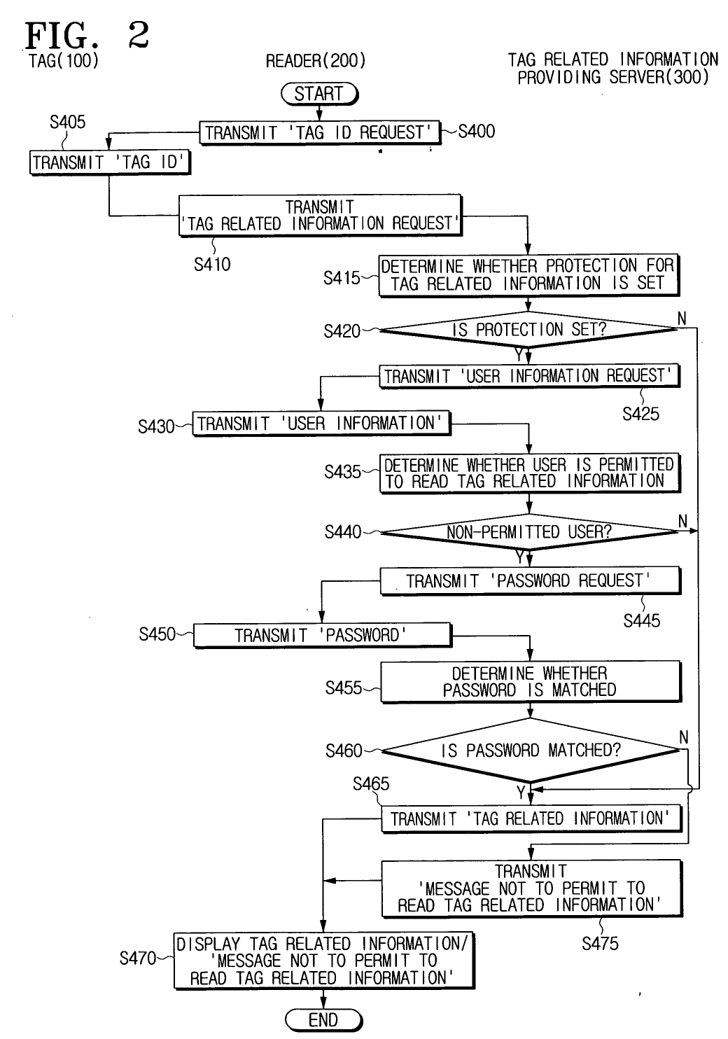

Hereafter, the process for protecting tag related information from a non-permitted user will be elucidated with reference to FIG. 2. The process is performed by providing the tag related information after performing an authentication process in the system for protecting the tag related information illustrated in FIG. 1. FIG. 2 is a flowchart for explaining a method of protecting tag related information according to an exemplary embodiment of the present invention.

FIG. 2 depicts operations of the tag 100 at the left, operations of the reader 200 at the center, and operations of the tag related information providing server 300 at the right for the convenience of understanding.

Referring to FIG. 2, the reader 200 transmits “tag ID request” to the tag 100 (S400). In detail, the reader 200 transmits an RF signal for “tag ID request” to the tag 100.

In response to the “tag ID request” received from the reader 200, the tag 100 transmits “tag ID” to the reader 200 (S405). In detail, the tag 100 generates an RF signal with “tag ID” that is stored in its memory to transmit to the reader 200.

When receiving the “tag ID” from the tag 100, the reader 200 transmits “tag related information request” to the tag related information providing server 300 (S410). The “tag related information request” includes the “tag ID” received from the tag 100.

When receiving the “tag related information request” from the reader 200, the tag related information providing server 300 determines whether protection for the tag related information is set (S415). In detail, referring to the tag ID included in the “tag related information request”, the tag related information providing server 300 finds corresponding tag related information among pre-stored various kinds of tag related information, and then determines whether the protection for the found tag related information is set.

The protection for the tag related information may be set before the operation S400 by an owner of the tag or an owner of a product to which the tag is attached. The owner may be an individual, an enterprise, an organization, a corporation or a public institution.

In detail, the protection for the tag related information is set as follows: i) when an owner requests the tag related information providing server 300 to set protection regarding certain tag related information, ii) the tag related information providing server 300 sets the protection regarding the requested tag related information. When the owner requests to set the protection regarding the tag related information, the tag ID and the authentication information thereof are transmitted together with the request to the tag related information providing server 300.

If the protection for the tag related information is set, a non-permitted user is restricted in reading the information. The set protection regarding the tag related information may be released by a request of the owner.

If it is determined that the protection regarding the tag related information is set in operation S415 (S420), the tag related information providing server 300 transmits “user information request” to the reader 200 (S425). The “user information” is information regarding a user of the reader 200, and has no limit to the sorts. Accordingly, the “user information” includes resident registration number, password, fingerprint, face, iris information, identification (ID), name, telephone number, e-mail address and any information that can distinguish a user.

In response to the “user information request” received from the tag related information providing server 300, the reader 200 transmits “user information” to the tag related information providing server 300 (S430). At this time, the reader 200 may transmit the “user information” input by a user, or automatically transmit the “user information” pre-stored in the reader 200.

If receiving the “user information” from the reader 200, the tag related information providing server 300 determines whether the user is permitted to read the tag related information by the received “user information” (S435).

If it is determined that the user is not permitted to read the tag related information in operation S435 (S440), the tag related information providing server 300 transmits “password request” to the reader 200 (S445). A password is registered for the tag related information.

In response to the “password request” received from the tag related information providing server 300, the reader 200 transmits “password” to the tag related information providing server 300 (S450). At this time, the reader 200 may transmit the “password” input by a user, or automatically transmit the “password” pre-stored in the reader 200, which is similar to operation S430.

When receiving the “password” from the reader 200, the tag related information providing server 300 determines whether the “password” matches the registered password (S455). In other words, it is determined whether the received password from the reader 200 matches the registered password in the tag related information providing server 300.

If it is determined that the “password” matches the registered password in operation S455 (S460), the tag related information providing server 300 transmits “tag related information” to the reader 200 (S465).

When receiving the “tag related information” from the tag related information providing server 300, the reader 200 displays the received “tag related information” on a display (S470). Accordingly, a user can read the tag related information through the reader 200.

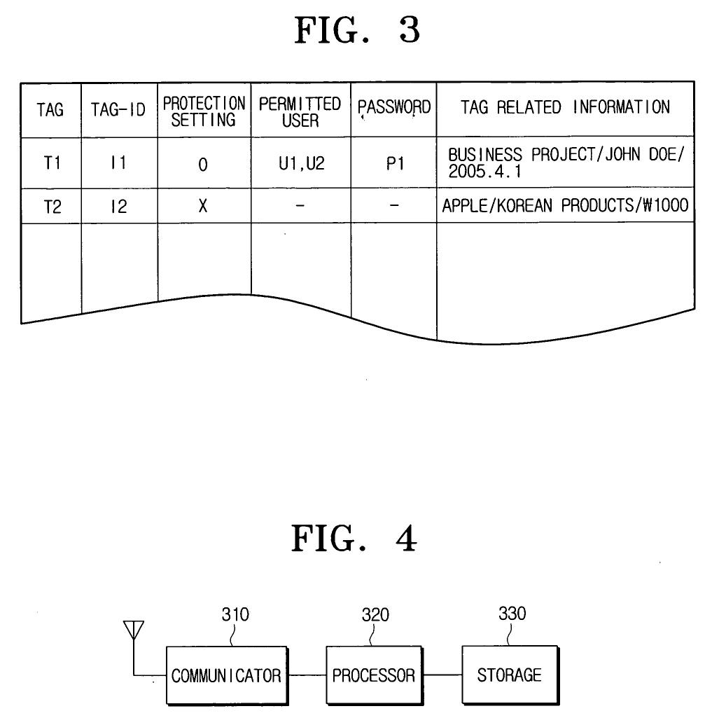

The above processes will be supplementarily explained with reference to FIG. 3. FIG. 3 illustrates a table that is pre-stored in the tag related information providing server 300 and includes database of the tag related information and data necessary for the authentication thereof. Referring to FIG. 3, the “protection setting” of the “tag related information” regarding the tag “T1”, the “tag ID” of which is “I1”, is made (“O”), and the “permitted user” is “U1” and “U2”, and the “password” is “P1”. The “protection setting” of the “tag related information” regarding the tag “T2”, the “tag ID” of which is “I2”, is not made (“X”), and accordingly, the “permitted user” and the “password” are not set.

Assume that the “tag ID” included in the transmitted “tag related information request” is “I1” in operation S410. The “protection setting” of the “tag related information” regarding the tag “T1”, the “tag ID” of which is “I1”, is made (“O”). Accordingly, it should be determined whether the user is permitted to read in operation S435. If the transmitted “user information” is “U3” in operation S430, it should be determined whether the “password” matches the registered password in operation S455 because “U3” is not a permitted user U1 or U2. If the transmitted “password” is “P1” in operation S450, the “tag related information” is transmitted to the reader 200 and displayed in operation S465 because the “password” matches the registered password. Here, the “tag related information” includes “business project” that is information on a product or a document to which the tag is attached, “John Doe” that is information on an owner of the product or the document, and “2005. 4. 1” that is information on the date on which the product or the document was made.

Referring back to FIG. 2, if it is determined that the “password” does not match the registered password in operation S455 (S460), the tag related information providing server 300 transmits a “message not to permit to read tag related information” to the reader 200 (S475). The reader 200 displays on a display the received “message not to permit to read tag related information” (S470). Therefore, a user can recognize that she is not permitted to read the tag related information.

Referring to FIG. 3, the above case is performed when the “tag ID” included in the transmitted “tag related information request” is “I1” in operation S410, when the transmitted “user information” is “U3” in operation S430, and when the transmitted “password” is “P2” in operation S450, that is, when the “password” does not match the registered password.

Meanwhile, if it is determined that the user is permitted to read the tag related information (S440), operations S445 through S460 are omitted but operations S465 and S470 are directly performed.

Referring to FIG. 3, the above case is directly performed, when the “tag ID” included in the transmitted “tag related information request” is “I1” in operation S410, and when the transmitted “user information” is “U1” or “U2” in operation S430, that is, when the user is permitted to read.

If it is determined that the protection for the tag related information is not set (S420), operations S425 through S460 are omitted but operations S465 and S470 are directly performed.

Referring to FIG. 3, the above case is performed when the “tag ID” included in the transmitted “tag related information request” is “I2” in operation S410, that is, when the protection for the tag related information is not set. The “tag related information” for the tag “T2”, the “tag ID” of which is “I2”, can be read by anybody without authentication processes. Here, the “tag related information” includes “apple” that is information on a product to which the tag is attached, “Korean products” that is information on a distributor of the product, and “1000” that is information on the price of the product.

Hitherto, the process of protecting the tag related information from non-permitted user by setting the protection for and providing the tag related information after authentication has been explained with an exemplary embodiment.

In the exemplary embodiment, the “user information” that is information regarding the user of the reader 200 is used to determine whether the user is permitted to read. However, the “user information” is an example of authentication information that is necessary for determining whether the user is permitted to read. This should not be considered as limiting. Any authentication information may be used to determine whether the user is permitted to read.

Besides the “user information”, the authentication information may include reader-information that is information on the reader 200 such as a unique number of the reader 200, and terminal information such as a unique number of a terminal to which the reader 200 is installed.

In the exemplary embodiment, the “user information” and the “password” used for the authentication are transmitted only when requested. However, this should not be considered as limiting. In other words, the “user information” and the “password” may be included in the “tag related information request” when the “tag related information request” is transmitted so that additional transmission may be previously prevented.

In the exemplary embodiment, the protection for the tag related information is divided into two grades, “protection required” and “protection non-required”. However, the protection may be divided into a plurality of grades. For example, the protection for the tag related information may be divided into i) “public” grade in which a general person is permitted to read all the tag related information, ii) “private” grade in which a general person is permitted to read a part of the tag related information, and iii) “protect” grade in which a general person is not permitted to read all the tag related information.

Hereafter, the tag related information providing server 300 illustrated in FIG. 1 will be explained in more detail with reference to FIG. 4. FIG. 4 is a block diagram of the tag related information providing server 300 illustrated in FIG. 1.

Referring to FIG. 4, the tag related information providing server 300 comprises a communicator 310, a processor 320 and a storage 330.

The communicator 310 communicates with the reader 200 according to a command of the processor 320.

The database table, as illustrated in FIG. 3, including the tag related information and data necessary for the authentication process is stored into the storage 330.

The processor 320 performs the operations illustrated at the right side of FIG. 2, and in detail, it performs the operation of determining whether the protection for the tag related information is set, the operation of determining whether a user is permitted to read the tag related information, and the operation of determining whether the input password matches the registered password. Furthermore, the processor 320 transmits the “user information request”, the “password request”, the “tag related information”, and the “message not to permit to read tag related information” through the communicator 310 to the reader 200.

FIG. 1 depicts that the reader 200 is wirelessly connected to the tag related information providing server 300; however, this should not be considered as limiting. Accordingly, the reader 200 may be wiredly connected to the tag related information providing server 300.

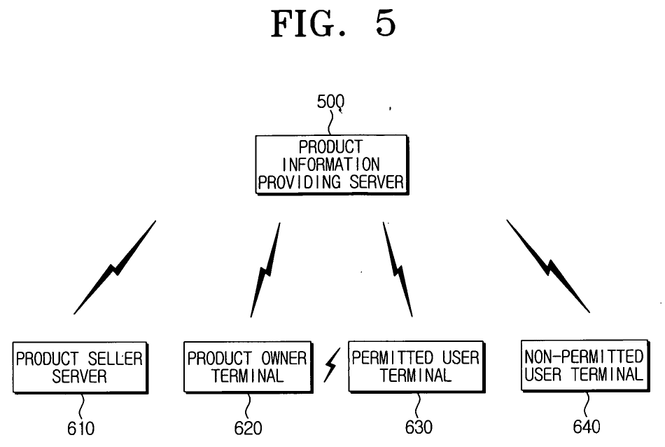

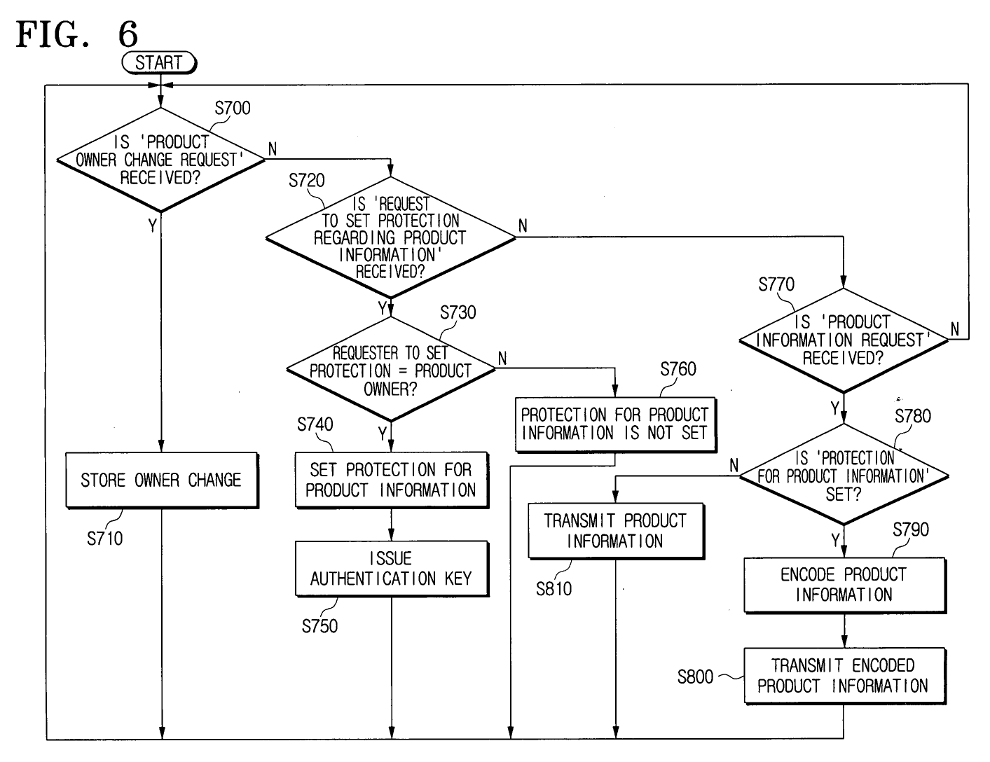

Hereafter, the protection for the tag related information according to another exemplary embodiment of the present invention will be elucidated with reference to FIGS. 5 and 6. FIG. 5 is a block diagram illustrating a system for protecting the tag related information according to the other exemplary embodiment of the present invention, and FIG. 6 is a flowchart for explaining a method of protecting the tag related information.

For the convenience of understanding, assume that the “tag related information” as information on a product to which the tag is attached (hereafter, referred to “product information”).

As illustrated in FIG. 5, the system for protecting the tag related information comprises a product information providing server 500, a product seller server 610, a product owner terminal 620, a permitted user terminal 630 and a non-permitted user terminal 640.

The product seller server 610 is provided in a shop of a product seller.

The product owner terminal 620 is carried by a product owner who obtains an ownership of a product through purchase or transfer of the product from the product seller. The product owner terminal 620 may request the product information providing server 500 to set the protection for the product information regarding the product which the product owner owns.

The permitted user terminal 630 is carried by a permitted user who is not a product owner but is permitted to read the product information for the product, protection of which is set by the product owner. The permitted user terminal 630 can be permitted to read the product information, the protection of which is set by the product owner terminal 620.

The non-permitted user terminal 640 is carried by a non-permitted user who is not permitted to read the product information, the protection of which is set by the product owner. In other words, the non-permitted user terminal 640 is not permitted to read the product information, the protection of which is set by the product owner terminal 620.

The product information providing server 500 stores the product information and transmits the product information to terminals requesting the product information. At this time, if the protection for the product information is set, the product information providing server 500 encodes the product information and transmits the encoded product information.

Hereafter, the operations of the tag related information protecting system illustrated in FIG. 5 will be elucidated with reference to FIG. 6.

As illustrated in FIG. 6, if receiving a “product owner change request” from the product seller server 610 (S700), the product information providing server 500 changes and stores the owner of the product to conform to the request (S710).

If the product is sold from the shop of the product seller, for example, 1) the product seller server 610 requests the product information providing server 500 for changing the ownership of the product from the product seller to the product purchaser, and 2) the product information providing server 500 receiving the request changes the ownership of the product from the product seller to the product purchaser or transferee, and stores information about the changed ownership in a pre-stored table.

The “product owner change request” includes the tag ID read from the tag which is attached to the product, and an owner-ID of the changed owner, and the product information providing server 500 changes and stores the owner of the product with reference to these IDs.

If receiving a request to set protection for the product information from the product owner terminal 620 (S720), the product information providing server 500 determines whether the protection setting requester is a product owner (S730).

When requesting to set the protection for the product information, the product owner terminal 620 transmits the tag ID together with the owner-ID. The tag ID can be obtained by reading the tag attached to a product when the protection for the product information regarding the product is tried to be set. The tag ID transmitted by the product owner terminal 620 is used for the product information providing server 500 to get the product information when it is requested to set the protection for the product information.

The owner-ID is information required to authenticate the product owner, and has no limit to sorts. Accordingly, the “owner-ID” includes 1) information on the product owner such as resident registration number, password, fingerprint, face, iris information, identification (ID), name, telephone number and e-mail address of the product owner, 2) information on the product owner terminal 620 such as ID and unique number of the product owner terminal 620, 3) information on a reader attached to the product owner terminal 620 such as ID and unique number of the reader, and 4) any information that can authenticate the product owner.

The product information providing server 500 determines whether the owner-ID received from the product owner terminal 620 matches the owner-ID pre-stored in the table to determine if the protection setting requester is the product owner. This is to prevent anybody, who has no authority for the product, from setting the protection for the product information.

If the protection setting requester is determined to be the product owner (S730-Y), the product information providing server 500 sets the protection for the product information (S740). The product information providing server 500 then issues an authentication key to the product owner terminal 620 (S750).

If the protection for the product information is set, when receiving the product information request, the product information providing server 500 encodes the product information and transmits the encoded product information. The issued “authentication key” is required to decode the encoded product information, which will be explained below.

The product owner terminal 620 which receives the authentication key from the product information providing server 500 can re-issue the authentication key to another terminal. The terminal, which receives the re-issued authentication key from the product owner terminal 620, is the aforementioned permitted user terminal 630, and the terminal, which does not receive the re-issued authentication key from the product owner terminal 620, is the aforementioned non-permitted user terminal 640.

If it is determined that the protection setting requester is not the product owner (S730-N), the product information providing server 500 does not set the protection for the product information (S760).

When receiving the product information request from the terminal (S770-Y), the product information providing server 500 determines whether the protection for the requested product information is set (S780).

If it is determined that the protection for the product information is set (S780-Y), the product information providing server 500 encodes the product information (S790). The product information providing server 500 transmits the encoded product information to the terminal requesting the product information (S800).

If it is determined that the protection for the requested product information is not set (S780-N), the product information providing server 500 does not encode the product information but transmits it as unchanged (S810).

The terminal requesting the product information providing server 500 for the product information may be the product owner terminal 620, the permitted user terminal 630 or the non-permitted user terminal 640. In other words, these three terminals can read the tag ID from the tag attached to the product and transmit the tag ID to the product information providing server 500 so as to request the product information providing server 500 for the product information regarding the product to which the tag is attached.

These three terminals can provide non-encoded product information as readable information to a user.

Because the product owner terminal 620 and the permitted user terminal 630 have the authentication key, they can decode the product information encoded by the product information providing server 500 so that the product owner terminal 620 and the permitted user terminal 630 can provide the product information as readable information to a user.

However, because the non-permitted user terminal 640 does not have the authentication key, it can not decode the product information encoded by the product information providing server 500 so that the non-permitted user terminal 640 can not provide the product information as readable information to a user.

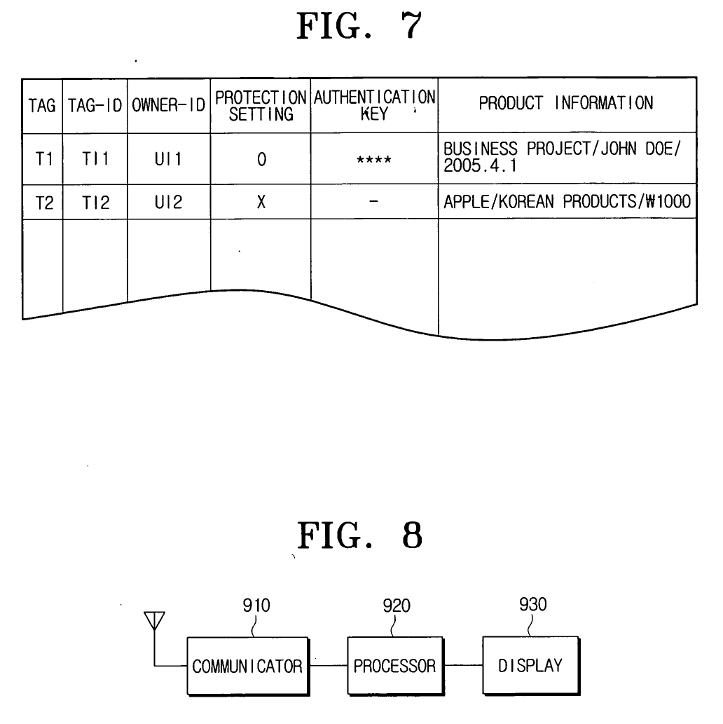

The above operations will be supplementarily explained with reference to FIG. 7. FIG. 7 illustrates a table that is pre-stored in the product information providing server 500 and includes database of the product information and data necessary for the authentication thereof.

Referring to FIG. 7, the owner-ID of the owner of the product to which the tag “T1” is attached, the “tag ID” of which is “TI1”, is “UI1”, and the “protection setting” for the “product information” is made (“O”), and the “authentication key” issued to the product owner terminal 620 is “****”. The owner-ID of the owner of the product to which the tag “T2” is attached, the “tag ID” of which is “TI2”, is “UI2”, and the “protection setting” for the “product information” is not made (“X”), and the “authentication key” is not issued.

Referring to the table of FIG. 7, the “owner-ID” is changed and stored when the product owner is changed through operations S700 and S710. The “protection setting” is made “O” when the protection for the product information is set through operations S720 through S740. The “authentication key” is issued to the product owner terminal 620 in operation S750.

If the product information requested in operation S770 is regarding the product to which the tag “T1” is attached, it is determined that the protection for the product information is set in operation S780 so that the product information is encoded and transmitted in operations S790 and S800.

If the product information requested in operation S770 is regarding the product to which the tag “T2” is attached, it is determined that the protection for the product information is not set in operation S780 so that the product information is not encoded but transmitted as unchanged in operation S810.

Hitherto, the process for protecting the product information from non-permitted user by encoding and providing the product information requiring the protection has been explained according to an exemplary embodiment of the present invention.

In the present exemplary embodiment, the information requiring the protection is exemplified as the product information regarding the product to which the tag is attached. However, this should not be considered as limiting. Another tag related information may be employed for the present exemplary embodiment.

In the present exemplary embodiment, the protection grade is divided into two grades, “protection required” and “protection non-required”. However, the protection may be divided into a plurality of grades. For example, the protection for the product information may be divided into i) “public” grade in which a general person is permitted to read all the product information, ii) “private” grade in which a general person is permitted to read a part of the product information, and iii) “protect” grade in which a general person is not permitted to read all the product information.

Furthermore, various protection grades may be employed. For example, various protection grades may be employed based on the age, sex distinction, residence, position such as family, corporation, and certain group, ID, residence registration number and telephone number of a user. Or, the protection grade, which is arbitrarily divided by the authentication key issuer or the product owner, may be employed.

In the present exemplary embodiment, the product seller server 610 sends the product information providing server 500 the “product owner change request”. However, if the product owner tries to change the product ownership to another person, the product owner terminal 620 may send the product information providing server 500 the “product owner change request”.

The product information providing server 500 illustrated in FIG. 5 may be implemented by the members illustrated in FIG. 4.

The communicator 310 performs communication with the product seller server 610, the product owner terminal 620, the permitted user terminal 630 and the non-permitted user terminal 640. The storage 330 stores a table including database of the product information and the data necessary for protecting the product information as illustrated in FIG. 7.

The processor 320 performs the operations illustrated in FIG. 7, and in detail, it performs the operations of changing the product owner, protecting the product information, issuing the authentication key, and encoding/transmitting the product information, the protection for which is set.

The terminals 620, 630 and 640 illustrated in FIG. 5 may be implemented as FIG. 8.

For example, the terminal 620 illustrated in FIG. 8 comprises a communicator 910, a processor 920 and a display 930.

The communicator 910 communicates with the product information providing server 500 and other terminals.

The processor 920 requests the product information providing server 500 through the communicator 910 to change the product ownership and set protection for the product information. The processor 920 stores the authentication key received through the communicator 910 from the product information providing server 500 or other terminals into a memory (not shown).

The processor 920 decodes the encoded product information received through the communicator 910 from the product information providing server 500 using the authentication key stored in the memory to display on the display 930. If the received product information is not encoded, the processor 920 displays the product information on the display 930 without decoding.

In the present exemplary embodiment, the device requesting the product information is a terminal with a reader or a terminal with a function of a reader. However, this should not be considered as limiting. Instead of a terminal, a reader may be employed for the device requesting the product information.

As described above, according to the exemplary embodiments of the present invention, the tag related information is provided after an authentication process or an encoding process so that the tag related information can be limited to read. Accordingly, a non-permitted user can be prevented from reading the tag related information so that the tag related information requiring the protection can be protected.

While the exemplary embodiments of the present invention are particularly shown and described with reference to RFID, the methods and apparatuses therein should not be considered as being limited to using radio frequency to implement the present invention. Instead, the present invention may also be implemented using various other types of signal emitting tag.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of protecting signal emitting tag related information comprising:
receiving a request for signal emitting tag related information, which comprises information related to a signal emitting tag; and
providing the signal emitting tag related information after authenticating the request.

2. The method as claimed in claim 1, further comprising determining whether protection for the signal emitting tag related information is set,
wherein, the signal emitting tag related information is provided after the authenticating of the request if it is determined that the protection is set.

3. The method as claimed in claim 2, wherein the providing of the signal emitting tag related information after the authenticating of the request comprises:
if it is determined that the protection is set, requesting a first authentication information necessary for the authenticating of the request;
receiving second authentication information and determining whether the signal emitting tag related information is permitted to be read using the second authentication information; and
if it is determined that the signal emitting tag related information is permitted to be read, providing the signal emitting tag related information.

4. The method as claimed in claim 3, wherein the first authentication information comprises at least one of information regarding a reader requesting the signal emitting tag related information, information regarding a terminal to which the reader is employed, and information regarding a user of the reader or the terminal.

5. The method as claimed in claim 3, further comprising:
if it is determined that the signal emitting tag related information is not permitted to be read, requesting a first password registered for the signal emitting tag related information;
determining whether the signal emitting tag related information is permitted to be read using a second password received in response to the requesting of the first password; and
if it is determined that the signal emitting tag related information is permitted to be read according to the second password, providing the signal emitting tag related information.

6. The method as claimed in claim 5, further comprising, if it is determined that the signal emitting tag related information is not permitted to be read according to the second password, transmitting a signal which represents not permitting reading of the signal emitting tag related information.

7. The method as claimed in claim 1, wherein authentication information, which comprises information necessary for the authenticating of the request, is received together with the request for the signal emitting tag related information.

8. The method as claimed in claim 1, further comprising:
requesting to set protection for the signal emitting tag related information; and
setting the protection for the signal emitting tag related information.

9. The method as claimed in claim 1, wherein the authenticating of the request comprises determining at least one of whether the signal emitting tag related information is permitted to be read, a first scope of the signal emitting tag related information if the signal emitting tag related information is permitted to be read, and whether a requester of the request is permitted to receive the signal emitting tag related information, and a second scope of the signal emitting tag related information if the requester is permitted to receive the signal emitting tag related information.

10. A system for protecting signal emitting tag related information, the system comprising:
a reader sending a request for signal emitting tag related information, which comprises information related to a signal emitting tag; and
a server providing the signal emitting tag related information to the reader after authenticating the request.

11. The system as claimed in claim 10, wherein, if it is determined that protection for the signal emitting tag related information is set, the server provides the signal emitting tag related information to the reader after the authenticating of the request.

12. The system as claimed in claim 11, wherein, if it is determined that the protection is set, the server determines whether to provide the signal emitting tag related information, based on first authentication information which comprises information necessary for the authenticating of the request.

13. The system as claimed in claim 12, wherein the reader is configured to send second authentication information which is input manually or pre-stored in the reader if the authenticating of the reader is requested.

14. The system as claimed in claim 10, wherein the authenticating of the request comprises determining at least one of whether the signal emitting tag related information is permitted to be read, a first scope of the signal emitting tag related information if the signal emitting tag related information is permitted to be read, and whether the reader is permitted to receive the signal emitting tag related information, and a second scope of the signal emitting tag related information if the reader is permitted to receive the signal emitting tag related information.

15. A signal emitting tag related information providing apparatus comprising:
a communicator which receives a request for signal emitting tag related information, which comprises information related to a signal emitting tag, from a reader which reads the signal emitting tag related information; and
a processor which provides the signal emitting tag related information through the communicator to the reader after authenticating the request.

16. The apparatus as claimed in claim 15, wherein, if it is determined that protection for the signal emitting tag related information is set, the processor provides the signal emitting tag related information through the communicator to the reader after the authenticating of the request.

17. The apparatus as claimed in claim 16, wherein, if it is determined that the protection for the signal emitting tag related information is set, the processor determines whether to provide the signal emitting tag related information, based on first authentication information which comprises information necessary for the authenticating of the request.

18. The apparatus as claimed in claim 15, wherein the authenticating of the request comprises determining at least one of whether the signal emitting tag related information is permitted to be read, a first scope of the signal emitting tag related information if the signal emitting tag related information is permitted to be read, and whether the reader is permitted to receive the signal emitting tag related information, and a second scope of the signal emitting tag related information if the reader is permitted to receive the signal emitting tag related information.

19. A method of protecting signal emitting tag related information comprising:
receiving a request for signal emitting tag related information which comprises information related to a signal emitting tag;
encoding the signal emitting tag related information; and
providing the encoded signal emitting tag related information.

20. The method as claimed in claim 19, further comprising determining whether protection for the signal emitting tag related information is set,
wherein, the encoding of the signal emitting tag related information is performed if it is determined that the protection is set.

21. The method as claimed in claim 20, further comprising:
receiving a signal emitting tag identification (ID) and a request for setting protection for the signal emitting tag related information; and
setting the protection using the signal emitting tag ID.

22. The method as claimed in claim 21, wherein the receiving of the signal emitting tag ID comprises receiving a first owner ID which specifies an owner of a product to which the signal emitting tag is attached, and
wherein the setting of the protection is performed if the first owner ID matches a predetermined second owner ID.

23. The method as claimed in claim 22, further comprising transmitting an authentication key, used for decoding the signal emitting tag related information, if the first owner ID matches a predetermined second owner ID.

24. The method as claimed in claim 21, further comprising transmitting an authentication key, used for decoding the signal emitting tag related information, after setting the protection.

25. The method as claimed in claim 19, further comprising:
receiving a signal emitting tag ID, a fourth owner ID and an owner change request; and
changing a third owner of a product, to which the signal emitting tag is attached, to a fourth owner specified by the fourth owner ID.

26. A method of protecting signal emitting tag related information, comprising:
sending a request for signal emitting tag related information which comprises information related to a signal emitting tag;
receiving encoded signal emitting tag related information in response to the request; and
decoding the encoded signal emitting tag related information.

27. The method as claimed in claim 26, further comprising receiving an authentication key, wherein the authentication key is used for the decoding of the encoded signal emitting tag related information.

28. The method as claimed in claim 27, further comprising transmitting the authentication key to a terminal of a permitted user so that the permitted user can read the encoded signal emitting tag related information using the authentication key.

29. The method as claimed in claim 27, wherein the authentication key is provided from a server providing the encoded signal emitting tag related information.

30. The method as claimed in claim 26, further comprising receiving a second authentication key from a terminal which receives a first authentication key, used for the decoding of the encoded signal emitting tag related information, and reissues the second authentication key, wherein the second authentication keys is also used for the decoding of the encoded signal emitting tag related information.
